(19) United States
(12) Patent Application Publication
(10) Pub. No.: US 2025/0253334 A1
(43) Pub. Date: Aug. 7, 2025

(54) POSITIVE ELECTRODE PLATE AND PREPARATION METHOD THEREOF, ELECTROCHEMICAL DEVICE, AND ELECTRICAL DEVICE

(71) Applicant: Ningde Amperex Technology Limited, Ningde (CN)

(72) Inventors: Taosheng WANG, Ningde (CN); Changming QU, Ningde (CN)

(73) Assignee: Ningde Amperex Technology Limited, Ningde (CN)

(21) Appl. No.: 19/042,014

(22) Filed: Jan. 31, 2025

(30) Foreign Application Priority Data
Feb. 1, 2024 (CN) 202410147402.8

(51) Int. Cl. H01M 4/62; H01M 4/02

(52) U.S. Cl. CPC H01M 4/62; H01M 2004/021; H01M 2004/028

(57) ABSTRACT

A positive electrode plate includes a positive current collector, a primer coating disposed on at least one surface of the positive current collector, and a positive active material layer disposed on a surface of the primer coating. The primer coating includes inorganic particles, a conductive agent, and a binder. A number of conductive agent particles agglomerated on the surface of the primer coating within an area of 2700 mm² is less than or equal to 2. The electrochemical device containing the positive electrode plate of this application exhibits a high level of safety performance, low-temperature discharge performance, and cycle performance simultaneously.

### CROSS-REFERENCE TO RELATED APPLICATION

This application claims priority to the Chinese Patent Application Ser. No. 202410147402.8, filed on Feb. 1, 2024, the content of which is incorporated herein by reference in its entirety.

### TECHNICAL FIELD

This application relates to the field of electrochemical technology, and in particular, to a positive electrode plate and a preparation method thereof, an electrochemical device, and an electrical device.

### BACKGROUND

Secondary batteries represented by a lithium-ion secondary battery are prominently characterized by a high energy density, a long cycle life, little pollution, no memory effect, and the like. Used as a clean energy source, the secondary batteries have been gradually applied to a wide range of fields from electronic products to large-sized devices such as an electric vehicle to meet the strategy of sustainable development of the environment and energy. This also imposes higher requirements on the safety performance, low-temperature discharge performance, and cycle performance of secondary batteries.

Therefore, finding an appropriate method to achieve high safety performance and good low-temperature discharge performance and cycle performance of secondary batteries is of great significance to the development of secondary batteries.

### SUMMARY

In view of the above problems in the prior art, some embodiments of this application provide a positive electrode plate and a preparation method thereof. In the positive electrode plate, the conductive agent is evenly distributed in a primer coating, so that the electrochemical device containing the positive electrode plate exhibits a high level of safety performance, low-temperature discharge performance, and cycle performance simultaneously.

A first aspect of this application provides a positive electrode plate. The positive electrode plate includes a positive current collector, a primer coating disposed on at least one surface of the positive current collector, and a positive active material layer disposed on a surface of the primer coating. The primer coating includes inorganic particles, a conductive agent, and a binder. The number of conductive agent particles agglomerated on the surface of the primer coating within an area of 2700 mm² is less than or equal to 2.

Without intending to be limited by any theory or explanation, the applicant hereof unexpectedly finds that the primer coating in the positive electrode plate includes inorganic particles, a conductive agent, and a binder, and the number of conductive agent particles agglomerated on the surface of the primer coating within an area of 2700 mm² is less than or equal to 2, so that the electrochemical device containing the positive electrode plate exhibits a high level of safety performance, low-temperature discharge performance, and cycle performance simultaneously. Specifically, the primer coating includes inorganic particles and possesses a resistance, and can effectively reduce dangerous short-circuit points between the positive current collector and the negative active material layer, and increase the short-circuit resistance when the electrochemical device is short-circuited, thereby reducing the heat generation power in a case of short-circuiting, and improving the safety performance of the electrochemical device. On the other hand, the number of the conductive agent particles agglomerated on the surface of the primer coating within an area of 2700 mm² is less than or equal to 2, indicating that the conductive agent is evenly distributed in the primer coating. The conductive agent evenly distributed on the surface of the primer coating can provide more conductive paths, thereby improving the interfacial contact between the primer coating and the positive active material layer, and in turn, improving the low-temperature discharge performance and cycle performance of the electrochemical device. Therefore, the electrochemical device containing the positive electrode plate of this application exhibits a high level of safety performance, low-temperature discharge performance, and cycle performance simultaneously.

In any embodiment, a difference in sheet resistance between any two 154.025 mm² regions on the primer coating is less than 1Ω.

Generally, a diameter of a circular terminal of a sheet resistance meter is 7 mm, and the area of the circular terminal is 154.025 mm². When the sheet resistances at any two positions on the primer coating are measured by using a sheet resistance meter, the difference in sheet resistance between the two positions is less than 1Ω, indicating that the sheet resistance fluctuates scarcely at each position on the primer coating and indicating that the conductive agent in the primer coating is evenly distributed and can provide a relatively large number of conductive paths, thereby improving the interfacial contact between the primer coating and the positive active material layer, and in turn, improving the low-temperature discharge performance and cycle performance of the electrochemical device.

Understandably, the sheet resistance bears the meaning well known in the art, and may be measured by a method well known in the art. As an example, the sheet resistance may be measured by the following method: disassembling an electrochemical device, taking out a part coated with only the primer coating, and using the part as a specimen; cleaning the specimen by soaking it in DMC, and then drying the specimen; and measuring the sheet resistance with a sheet resistance meter by applying a pressure of 0.4 T and holding the pressure for a time of 10 s. The value displayed by the sheet resistance meter is the sheet resistance of the primer coating at the corresponding test point.

In any embodiment, a pH value of powder of the primer coating is 7 to 8. In this application, a method for measuring the pH value of the powder of the primer coating is as follows: soaking approximately 1 gram of the primer coating in 50 ml of deionized water in a 25° C. environment, stirring the solution with a magnetic stirrer at a speed of 30 r/min for 12 hours so that the primer coating is automatically dispersed in the deionized water, and then measuring the pH value of the solution by using a pH tester. The pH value of the powder of the primer coating roughly reflects the pH value of the primer slurry. The pH value falling within the range of 7 to 8 is conducive to uniform distribution of the conductive agent in the slurry and availability of a relatively large number of conductive paths, thereby improving the interfacial contact between the primer coating and the positive active material layer, and in turn, improving the low-temperature discharge performance and cycle performance of the electrochemical device.

In any embodiment, the primer slurry further includes an alkali metal carbonate salt. The alkali metal carbonate salt is a weak base salt that ionizes into hydroxide ions in an aqueous solvent, thereby making the primer slurry alkaline, for example, making the pH value of the slurry be 7 to 8. This is conducive to uniform distribution of the conductive agent in the slurry and provides a relatively large number of conductive paths, thereby improving the interfacial contact between the primer coating and the positive active material layer, and in turn, improving the low-temperature discharge performance and cycle performance of the electrochemical device.

In any embodiment, the alkali metal carbonate salt includes at least one of sodium carbonate, lithium carbonate, potassium carbonate, sodium bicarbonate, lithium bicarbonate, potassium bicarbonate, or the like. The above types of alkali metal carbonate salts applied to the primer slurry are not only conducive to uniform distribution of the conductive agent in the slurry and provide a relatively large number of conductive paths, but also the alkali metal carbonate salts include lithium ions or sodium ions that can improve the electronic conductivity and ionic conductivity of the positive electrode plate, thereby further improving the low-temperature discharge performance and cycle performance of the electrochemical device.

In any embodiment, the alkali metal carbonate salt includes sodium carbonate and lithium carbonate. Sodium carbonate and lithium carbonate can work synergistically. The strong ionization ability of the sodium carbonate provides an alkaline environment, and the lithium carbonate provides a rich source of lithium ions, thereby being not only conducive to uniform distribution of the conductive agent, but also conducive to charge exchange and charge-discharge reactions, and in turn, further improving the cycle performance and low-temperature discharge performance in contrast to the sodium carbonate alone or the lithium carbonate alone.

In any embodiment, based on a total mass of the primer coating, the primer coating includes the inorganic particles added at a mass percent of 80 wt % to 90 wt %, the conductive agent added at a mass percent of 3 wt % to 20 wt %, the binder added at a mass percent of 0.5 wt % to 10 wt %, and an alkali metal carbonate salt added at a mass percent of 0.5 wt % to 2 wt %.

In the primer coating made of the above constituents, the inorganic particles and the conductive agent can effectively balance the short-circuit resistance and conductivity, so that the primer coating can possess a high short-circuit resistance while being able to provide electron and ion transmission channels, thereby improving safety performance. The alkali metal carbonate salt is conducive to uniform distribution of the conductive agent in the primer coating and provides a relatively large number of conductive paths, thereby improving the interfacial contact between the primer coating and the positive active material layer, and in turn, improving the low-temperature discharge performance and cycle performance of the electrochemical device. In addition, the binder firmly bonds the primer coating to the surface of the positive current collector, thereby further improving the safety performance of the electrochemical device.

In any embodiment, the binder is a water-soluble polyacrylate metal salt compound. The water-soluble polyacrylate metal salt compound possesses a relatively large specific surface area, and is highly dispersible upon contact with water, and is of relatively high physical tensile strength. In addition, the surface of the water-soluble polyacrylate metal salt compound includes a relatively large number of polar functional groups that can boost the interaction between the primer coating and the current collector and enhance the adhesion of the interface, thereby improving the safety performance of the electrochemical device.

In any embodiment, the binder in the primer coating is an alkali metal polyacrylate salt binder.

In any embodiment, the alkali metal polyacrylate salt binder includes lithium polyacrylate and sodium polyacrylate. The lithium polyacrylate can provide abundant lithium ions. The lithium ions can participate in deintercalation reactions during charge and discharge, thereby improving the transmission rate and reactivity of lithium ions in the positive active material layer, and in turn, improving the capacity of the battery. The sodium polyacrylate works together with the lithium polyacrylate to provide more conductive paths for lithium ions and improve the interfacial contact between the primer coating and the positive active material.

The alkali metal polyacrylate salt binder is prone to cause agglomeration of the conductive agent and result in uneven dispersion of the slurry, and therefore, needs to be coordinated by an alkali metal carbonate salt. Through the coordination, the conductive agent can still be evenly dispersed in the slurry even when the alkali metal polyacrylate salt binder is used.

In any embodiment, a mass ratio of lithium carbonate to sodium carbonate is 0.5 to 4, and preferably 2 to 4.

Both lithium carbonate and sodium carbonate can ionize into carbonate ions. The ionization strength of sodium carbonate is greater than that of lithium carbonate. Using lithium carbonate and sodium carbonate at the above mass ratio can provide abundant carbonate ions on the one hand. The carbonate ions are hydrolyzed to generate bicarbonate ions and hydroxide ions, thereby making the primer slurry alkaline, for example, making the pH value of the primer slurry be 7 to 8. This is conducive to uniform distribution of the conductive agent in the primer coating, and provides a relatively large number of conductive paths, thereby improving the low-temperature discharge performance and cycle performance of the electrochemical device. On the other hand, more lithium ions are provided and conducive to charge exchange during charge and discharge. In addition, the lithium carbonate can participate in intercalation and deintercalation reactions of lithium ions during charge and discharge, thereby improving the transmission rate and reactivity of lithium ions in the positive active material, and in turn, improving the capacity of the electrochemical device.

In any embodiment, a thickness of the primer coating is 1 μm to 5 μm. In some embodiments, the thickness of the primer coating is 1 μm to 5 μm. For example, the thickness of the primer coating is 1 μm, 2 μm, 3 μm, 4 μm, 5 μm, or a value falling within a range formed by any two thereof. Optionally, the thickness of the primer coating is 2 μm. The primer coating of the positive electrode plate in an embodiment of this application may be disposed on a part of the surface of the positive current collector, or may completely cover the surface of the positive current collector.

With the thickness of the primer coating falling within the above appropriate range, on the one hand, the primer coating can effectively separate the positive current collector from the positive active material layer, thereby improving the safety performance of the electrochemical device. On the other hand, the appropriate thickness of the primer coating contributes to an appropriate resistance of the primer coating and sufficient conductive paths, and makes the electrochemical device exhibit good low-temperature discharge performance and cycle performance.

A second aspect of this application provides a preparation method of a positive electrode plate, including:
applying a primer slurry onto at least one surface of a positive current collector, and then performing drying and cold-pressing to form a primer coating, where the primer slurry includes inorganic particles, a conductive agent, a binder, and an alkali metal carbonate salt, and a pH value of the primer slurry is 7 to 8; and
applying a positive active material slurry onto the primer coating, and performing drying and cold-pressing to form a positive active layer and obtain the positive electrode plate.

Without intending to be limited by any theory or explanation, the applicant hereof unexpectedly finds that, by adding an alkali metal carbonate salt into the primer slurry, the primer slurry is made alkaline, and the pH value of the primer slurry is caused to be 7 to 8, thereby being conducive to uniform distribution of the conductive agent in the slurry. In the primer coating, the uniformly distributed conductive agent can provide a relatively large number of conductive paths, thereby improving the interfacial contact between the primer coating and the positive active material layer, and in turn, improving the low-temperature discharge performance and cycle performance of the electrochemical device. On the other hand, the primer coating formed between the positive current collector and the positive active material layer can effectively reduce dangerous short-circuit points between the positive current collector and the negative active material layer, and increase the short-circuit resistance when the electrochemical device is short-circuited, thereby reducing the heat generation power in a case of short-circuiting, and improving the safety performance of the electrochemical device. Therefore, the electrochemical device containing the positive electrode plate prepared by the above preparation method exhibits a high level of safety performance, low-temperature discharge performance, and cycle performance simultaneously.

In any embodiment, based on a total mass of the inorganic particles, the conductive agent, the binder, and the alkali metal carbonate salt, a mass ratio between the inorganic particles, the conductive agent, the binder, and the alkali metal carbonate salt is (80 to 90):(3 to 20):(0.5 to 10):(0.5 to 2).

In the primer slurry formed of the above constituents, the inorganic particles and the conductive agent can effectively balance the short-circuit resistance and conductivity, so that the primer coating can possess a high short-circuit resistance while being able to provide electron and ion transmission channels, thereby improving safety performance. The alkali metal carbonate salt is conducive to uniform distribution of the conductive agent in the primer coating and provides a relatively large number of conductive paths, thereby improving the interfacial contact between the primer coating and the positive active material layer, and in turn, improving the low-temperature discharge performance and cycle performance of the electrochemical device. In addition, the binder firmly bonds the primer coating to the surface of the positive current collector, thereby further improving the safety performance of the electrochemical device.

In any embodiment, the alkali metal carbonate salt is at least one selected from sodium carbonate, lithium carbonate, potassium carbonate, sodium bicarbonate, lithium bicarbonate, potassium bicarbonate, or the like. The above types of alkali metal carbonate salts are not only conducive to uniform distribution of the conductive agent in the primer slurry and provide a relatively large number of conductive paths, but also the alkali metal carbonate salts include lithium ions or sodium ions that can improve the electronic conductivity and ionic conductivity of the positive electrode plate, thereby further improving the low-temperature discharge performance and cycle performance of the electrochemical device.

In any embodiment, the alkali metal carbonate salt includes sodium carbonate and lithium carbonate. The sodium carbonate can ionize into sodium ions and carbonate ions. The carbonate ions are hydrolyzed to generate bicarbonate ions and hydroxide ions, thereby making the primer slurry alkaline, for example, making the pH value of the primer slurry be 7 to 8. This is conducive to uniform distribution of the conductive agent in the primer coating, and provides a relatively large number of conductive paths, thereby improving the low-temperature discharge performance and cycle performance of the electrochemical device. The lithium carbonate can not only ionize into carbonate ions and provide an alkaline environment, which is conducive to uniform distribution of the conductive agent in the primer coating, but also ionize into lithium ions and provide more lithium ions, thereby being conducive to charge exchange during charge and discharge. In addition, the lithium carbonate can participate in intercalation and deintercalation reactions of lithium ions during charge and discharge, thereby improving the transmission rate and reactivity of lithium ions in the positive active material, and in turn, improving the capacity of the electrochemical device.

A third aspect of this application provides an electrochemical device. The electrochemical device includes the positive electrode plate according to the first aspect of this application or a positive electrode plate prepared by the preparation method according to any one of the embodiments in the second aspect of this application.

A fourth aspect of this application provides an electrical device. The electrical device includes the electrochemical device according to the third aspect of this application.

### BRIEF DESCRIPTION OF DRAWINGS

One or more embodiments are described illustratively with reference to corresponding drawings. The illustrative description does not constitute any limitation on the embodiments. Components marked with the same reference numeral in the drawings represent similar components. Unless otherwise expressly specified, the drawings are not drawn to scale.

FIG. 1 is a schematic diagram of a positive electrode plate according to some embodiments of this application;

FIG. 2 is a surface diagram of a primer coating of a positive electrode plate according to some embodiments of this application;

FIG. 3 is a schematic diagram of different measurement points selected according to some embodiments of this application;

FIG. 4(a) is a surface diagram of a primer coating powder with a pH value of 7 to 8 according to some embodiments of this application;

FIG. 4(b) is a surface diagram of a primer coating powder with a pH value of 4 to 5 in contrast; and

FIG. 5 is a comparison diagram of discharge curves at −10° C. and 0.4 C for an electrochemical device with a pH value of 7 to 8 and an electrochemical device with a pH value of 4 to 5 according to some embodiments of this application.

### DETAILED DESCRIPTION

The following describes in detail a positive electrode plate and a preparation method thereof, an electrochemical device, and an electrical device according to some embodiments of this application with due reference to drawings. However, unnecessary details may be omitted in some cases. For example, a detailed description of a well-known matter or repeated description of an essentially identical structure may be omitted. That is intended to prevent the following descriptions from becoming unnecessarily lengthy, and to facilitate understanding by a person skilled in the art. In addition, the drawings and the following descriptions are intended for a person skilled in the art to thoroughly understand this application, but not intended to limit the subject-matter set forth in the claims.

A “range” disclosed herein is defined in the form of a lower limit and an upper limit. A given range is defined by a lower limit and an upper limit selected. The selected lower and upper limits define the boundaries of a particular range. A range so defined may be inclusive or exclusive of the end values, and a lower limit of one range may be arbitrarily combined with an upper limit of another range to form a range. For example, if a given parameter falls within a range of 60 to 120 and a range of 80 to 110, it is expectable that the parameter may fall within a range of 60 to 110 and a range of 80 to 120 as well. In addition, if lower-limit values 1 and 2 are listed, and if upper-limit values 3, 4, and 5 are listed, the following ranges are all expectable: 1 to 3, 1 to 4, 1 to 5, 2 to 3, 2 to 4, and 2 to 5. Unless otherwise specified herein, a numerical range “a to b” is a brief representation of a combination of any real numbers between a and b inclusive, where both a and b are real numbers. For example, a numerical range “0 to 5” herein means all real numbers recited between 0 and 5 inclusive, and the expression “0 to 5” is just a brief representation of a combination of such numbers. In addition, a statement that a parameter is an integer greater than or equal to 2 is equivalent to a disclosure that the parameter is an integer such as 2, 3, 4, 5, 6, 7, 8, 9, 10, 11, 12, and so on.

Unless otherwise expressly specified herein, any embodiments and optional embodiments hereof may be combined with each other to form a new technical solution.

Unless otherwise expressly specified herein, any technical features and optional technical features hereof may be combined with each other to form a new technical solution.

Unless otherwise expressly specified herein, “include” and “comprise” mentioned herein mean open-ended inclusion, or closed-ended inclusion. For example, the terms “include” and “comprise” may mean inclusion of other items that are not recited, or inclusion of only the items recited.

Unless otherwise expressly specified, the term “or” used herein is inclusive. For example, the expression “A or B” means “A alone, B alone, or both A and B”. More specifically, all and any of the following conditions satisfy the condition “A or B”: A is true (or existent) and B is false (or absent); A is false (or absent) and B is true (or existent); and, both A and B are true (or existent).

A first aspect of this application provides a positive electrode plate. The positive electrode plate includes a positive current collector, a primer coating disposed on at least one surface of the positive current collector, and a positive active material layer disposed on a surface of the primer coating. The primer coating includes inorganic particles, a conductive agent, and a binder. The number of conductive agent particles agglomerated on the surface of the primer coating within an area of 2700 mm² is less than or equal to 2.

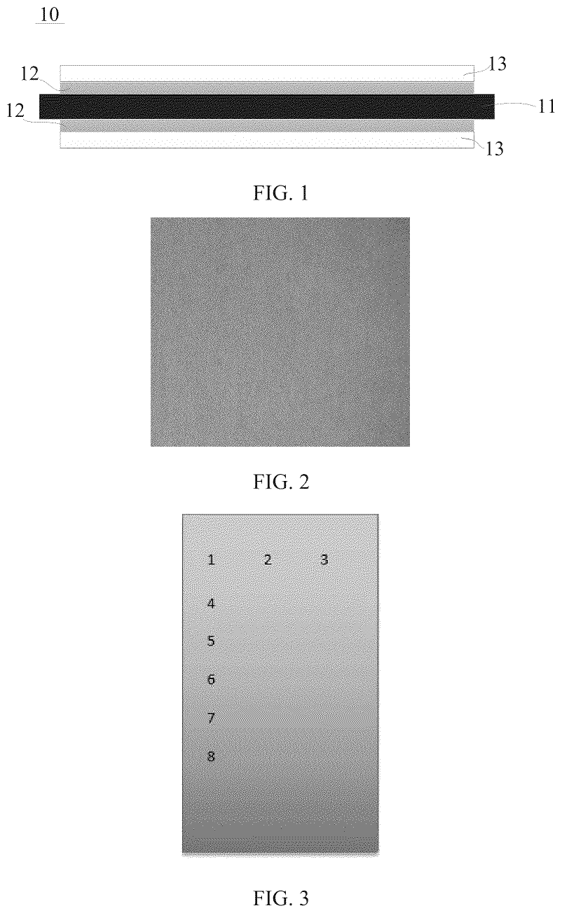

FIG. 1 is a schematic diagram of a positive electrode plate according to an embodiment of this application. The exemplary positive electrode plate 10 includes a positive current collector 11, a primer coating 12 disposed on both surfaces of the positive current collector, and a positive active material layer 13 disposed on a surface of the primer coating.

The primer coating 12 includes inorganic particles, a conductive agent, and a binder. As an example, a slurry that includes inorganic particles, a conductive agent, and a binder is applied onto a surface of the positive current collector 11, and then dried and cold-pressed to form the primer coating 12.

The inorganic particles may be selected from inorganic particles known in the art suitable for use in a primer coating, and are not limited herein. As an example, the inorganic particles may be one or more selected from ceramics, boehmite, aluminum oxide, titanium dioxide, magnesium oxide, zirconium oxide, zinc oxide, or the like.

The above binder may be selected from binders known in the art suitable for use in a primer coating, and is not limited herein. In some embodiments, the binder is a water-soluble metal salt compound, for example, selected from an alkali metal polyacrylate salt and/or an alkaline earth metal polypropylene salt, or the like. As an example, the binder includes at least one of a lithium, sodium, or potassium alkali metal salt and/or an alkaline earth metal salt. For example, the binder includes lithium polyacrylate and sodium polyacrylate.

The above conductive agent may be selected from conductive agents known in the art suitable for use in a primer coating, and is not limited herein. As an example, the conductive agent includes at least one of conductive carbon black, small-grained conductive carbon black (Super P), carbon nanotubes, Ketjen black, conductive graphite, or vapor grown carbon fibers (VGCF).

The agglomerated conductive agent particles mean clusters agglomerated from the conductive agent in the primer coating. The agglomerated conductive agent particles possess an agglomerate diameter, such as a diameter greater than 40 μm. Understandably, if the conductive agent agglomerates in the primer coating slurry, the agglomerated conductive agent particles are likely to appear on the surface of the primer coating after the slurry forms a primer coating. Therefore, the agglomerated conductive agent particles can be distinguished based on the color of the conductive agent, so as to characterize the distribution of the conductive agent in the primer coating or slurry.

In the positive electrode plate according to an embodiment of this application, the number of conductive agent particles agglomerated on the surface of the primer coating within an area of 2700 mm² is less than or equal to 2. For example, the number of conductive agent particles agglomerated on the surface of the primer coating within a 30 mm×90 mm area is 0, 1, or 2 (this number is an average value, rounded off). In other words, the conductive agent is evenly distributed in the primer coating, and can form a larger number of uniform conductive paths.

It is hereby noted that the number of conductive agent particles agglomerated on the surface of the primer coating may be determined through observation by using a visual sensor such as charge coupled device (Charge Coupled Device, CCD) sensor. Specifically, the observation may be carried out through the following steps: taking a piece of 90 mm×30 mm in size from the outermost positive electrode plate of a battery to serve as a specimen to be observed (generally, the outermost positive electrode plate of a battery is not coated with a positive active material layer, but exposes the primer coating); or, purchasing a positive electrode plate or disassembling a battery to take out a positive electrode plate, soaking the positive electrode plate in dimethyl carbonate (Dimethyl carbonate, DMC), and then baking the positive electrode plate in an 80° C. oven for 30 minutes, using 3M adhesive tape to peel off the superficial positive active material layer to obtain a positive electrode plate with an exposed primer coating, and taking a piece of 90 mm×30 mm in size from the positive electrode plate to serve as a specimen to be observed; placing the specimen onto a specimen holder, using a CCD observation probe with a diameter of 1 cm, adjusting the distance between the CCD observation probe and the specimen holder to 3 cm, adjusting the magnification to 20×, and determining the number of conductive agent particles agglomerated on the surface of the specimen. For example, if the conductive agent includes a black conductive material such as conductive carbon or graphite, the number of black spots observed on the surface of the specimen is the number of agglomerated conductive agent particles.

As shown in FIG. 2, FIG. 2 is a surface diagram of a primer coating of a positive electrode plate according to an embodiment of this application. In this embodiment, the conductive agent includes a black conductive material such as conductive carbon or graphite. As can be seen from FIG. 2, the surface of the primer coating is uniform in color, and is free from agglomerated conductive agent particles. Therefore, it is determined that the conductive agent is evenly distributed in the primer coating, and forms a larger number of uniform conductive paths.

Without intending to be limited by any theory or explanation, the applicant hereof unexpectedly finds that the primer coating in the positive electrode plate includes inorganic particles, a conductive agent, and a binder, and the number of conductive agent particles agglomerated on the surface of the primer coating within an area of 2700 mm² is less than or equal to 2, so that the electrochemical device containing the positive electrode plate exhibits a high level of safety performance, low-temperature discharge performance, and cycle performance simultaneously. Specifically, the primer coating includes inorganic particles and possesses a resistance, and can effectively reduce dangerous short-circuit points between the positive current collector and the negative active material layer, and increase the short-circuit resistance when the electrochemical device is short-circuited, thereby reducing the heat generation power in a case of short-circuiting, and improving the safety performance of the electrochemical device. On the other hand, the number of the conductive agent particles agglomerated on the surface of the primer coating within an area of 2700 mm² is less than or equal to 2, indicating that the conductive agent is evenly distributed in the primer coating. The conductive agent evenly distributed on the surface of the primer coating can provide more conductive paths, thereby improving the interfacial contact between the primer coating and the positive active material layer, and in turn, improving the low-temperature discharge performance and cycle performance of the electrochemical device. Therefore, the electrochemical device containing the positive electrode plate of this application exhibits a high level of safety performance, low-temperature discharge performance, and cycle performance simultaneously.

In this application, for the positive electrode plate in an embodiment of this application and other contrast positive electrode plates separately, the sheet resistance is measured at 8 test points shown in FIG. 3 by using a sheet resistance meter according to the above test method. In FIG. 3, the digits 1 to 8 are the reference numerals of the test points.

The pH value of the powder of the primer coating of the positive electrode plate in an embodiment of this application is 7 to 8. The pH value of the powder of the primer coating of the contrast positive electrode plate is 4 to 5. The test results are shown in Table 1 below.

TABLE 1

| Test point | 1 | 2 | 3 | 4 | 5 | 6 | 7 | 8 |
|---|---|---|---|---|---|---|---|---|
| pH 7 to 8, | 4.18 | 4.23 | 4.28 | 4.28 | 4.13 | 4.36 | 4.38 | 4.33 |
| sheet | | | | | | | | |
| resistance | | | | | | | | |
| (Ω) | | | | | | | | |
| pH 4 to 5, | 3.44 | 4.93 | 4.98 | 2.95 | 9.29 | 5.20 | 7.62 | 8.09 |
| sheet | | | | | | | | |
| resistance | | | | | | | | |
| (Ω) | | | | | | | | |

As can be seen from Table 1, the pH value of the powder of the primer coating of the positive electrode plate in an embodiment of this application is 7 to 8, and an extreme difference in sheet resistance between a plurality of test points is less than 1Ω, that is, the difference in sheet resistance between any two test points is less than 1Ω. This further illustrates that the pH value of the primer coating powder falling within the range of 7 to 8 is conducive to uniform distribution of the conductive agent in the primer coating and can provide a relatively large number of conductive paths. Such pH values are conducive to improving the interfacial contact between the primer coating and the positive active material layer, thereby improving the low-temperature discharge performance and cycle performance of the electrochemical device.

As can be seen from Table 1, the pH value of the powder of the primer coating of the contrast positive electrode plate is 4 to 5. The sheet resistance at these test points fluctuates sharply, with an extreme difference being up to 6.34Ω, indicating that the conductive agent is unevenly distributed in the primer coating and the conductivity in some regions is low, thereby being detrimental to the low-temperature discharge performance and cycle performance.

Therefore, the pH value of the primer coating powder falling within the range of 7 to 8 is conducive to uniform distribution of the conductive agent, and contributes to a relatively large number of conductive paths, thereby improving the interfacial contact between the primer coating and the positive active material layer, and in turn, improving the low-temperature discharge performance and cycle performance of the electrochemical device.

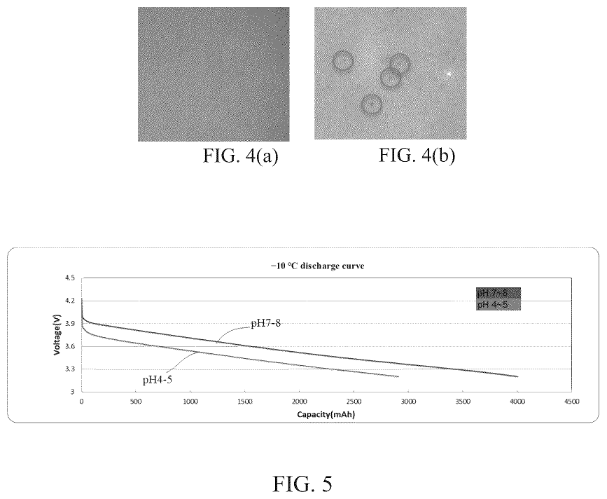

Referring to FIG. 4, FIG. 4(a) is a surface diagram of a primer coating powder with a pH value of 7 to 8 according to some embodiments of this application, and FIG. 4(b) is a surface diagram of a primer coating powder with a pH value of 4 to 5 in contrast. As can be seen from FIG. 4(a), the surface of the primer coating powder with a pH value of 7 to 8 is uniform in color, and is free from agglomerated conductive agent particles, indicating that the conductive agent is evenly distributed in the primer coating. As can be seen from Table 4(b), the surface of the primer coating powder with a pH value of 4 to 5 displays a considerable number of black spots (here “black spots” are agglomerated conductive agent particles), indicating that the conductive agent is unevenly distributed in the primer coating powder with a pH value of 4 to 5 and the conductivity is nonuniform, thereby being detrimental to the low-temperature discharge performance and cycle performance.

Without intending to be limited by any theory or explanation, the uniform distribution of the conductive agent in the primer coating makes the conductive paths form a uniformly distributed network structure, thereby improving the interfacial contact between the primer coating and the positive active material layer, and in turn, improving the low-temperature discharge performance and cycle performance of the electrochemical device.

Referring to FIG. 5, FIG. 5 is a comparison diagram of discharge curves at −10° C. and 0.4 C for an electrochemical device with a pH value of 7 to 8 and an electrochemical device with a pH value of 4 to 5. In the electrochemical device marked with a pH value of 7 to 8, the pH value of the primer coating powder of the positive electrode plate is 7 to 8. In the electrochemical device marked with a pH value of 4 to 5, the pH value of the primer coating powder of the positive electrode plate is 4 to 5.

As can be seen from FIG. 5, during discharge, at the same discharge capacity, the terminal voltage of the electrochemical device marked with a pH value of 7 to 8 is always higher than the terminal voltage of the electrochemical device marked with a pH value of 4 to 5. The higher the terminal voltage, the lower the concentration polarization, the lower the internal resistance, and the higher the internal electrochemical reaction rate. In other words, the electrochemical device marked with a pH value of 7 to 8 possesses a relatively low resistance at low temperature, and therefore, exhibits superior low-temperature discharge performance.

Therefore, it is determined that the pH value of the primer coating powder falling within the range of 7 to 8 can effectively improve the low-temperature discharge performance of the electrochemical device.

The positive current collector of the positive electrode plate in an embodiment is not particularly limited herein. In some embodiments, the positive current collector may be metal foil or a composite current collector. As an example of the metal foil, the positive current collector may be an aluminum foil. The composite current collector may include a polymer material substrate and a metal material layer formed on at least one surface of the polymer material substrate. As an example, the metal material may be one or more selected from aluminum, aluminum alloy, nickel, nickel alloy, titanium, titanium alloy, silver, or silver alloy. As an example, the polymer material substrate may be selected from polypropylene, polyethylene terephthalate, polybutylene terephthalate, polystyrene, polyethylene, or the like.

In some embodiments, the positive current collector includes two surfaces opposite to each other in a thickness direction of the current collector, and the primer coating may be disposed on one or both of the two surfaces of the positive current collector. For example, the positive current collector includes two surfaces opposite to each other in the thickness direction of the current collector, and the primer coating is disposed on any one or both of the two surfaces on the two opposite sides of the positive current collector.

The positive electrode plate includes at least one positive active material layer. The positive active material layer may be disposed on one surface of the positive current collector, or disposed on both surfaces of the positive current collector, and at least one positive active material layer is disposed on a surface of the primer coating.

In some embodiments, the specific type of the positive active material in the positive active material layer is not particularly limited, and may be selected as required. As an example, the positive active material may include one or more of lithium transition metal oxide, olivine-structured lithium-containing phosphate, or a modified compound thereof. In an embodiment of this application, the modified compound of the positive active material may be formed by modification of the positive active material, where the modification is doping, surface coating, or both doping and surface coating.

As an example, the lithium transition metal oxide may include one or more of lithium cobalt oxide, lithium nickel oxide, lithium manganese oxide, lithium nickel cobalt oxide, lithium manganese cobalt oxide, lithium nickel manganese oxide, lithium nickel cobalt manganese oxide, lithium nickel cobalt aluminum oxide, or a modified compound thereof. As an example, the olivine-structured lithium-containing phosphate may include one or more of lithium iron phosphate, a composite of lithium iron phosphate and carbon, lithium manganese phosphate, a composite of lithium manganese phosphate and carbon, lithium manganese iron phosphate, a composite of lithium manganese iron phosphate and carbon, or a modified compound thereof. Of such positive active materials, one may be used alone, or at least two may be used in combination.

In some embodiments, the positive active material layer further optionally includes a conductive agent. As an example, the conductive agent may include at least one of superconductive carbon, acetylene black, carbon black, Ketjen black, carbon dots, carbon nanotubes, graphene, or carbon nanofibers.

In some embodiments, the positive active material layer further optionally includes a binder. As an example, the binder includes polymer materials such as polytetrafluoroethylene or polypropylene.

A second aspect of this application provides a preparation method of a positive electrode plate. The preparation method S10 includes, but is not limited to, the following steps:

S11: Applying a primer slurry onto at least one surface of a positive current collector, and then performing drying and cold-pressing to form a primer coating, where the primer slurry includes inorganic particles, a conductive agent, a binder, and an alkali metal carbonate salt, and a pH value of the primer slurry is 7 to 8.

The primer slurry is prepared in advance by the following exemplary method: dispersing inorganic particles, a conductive agent, a binder, and an alkali metal carbonate salt in a solvent, and stirring well to form a uniform primer slurry, where the pH value of the primer slurry is 7 to 8. Subsequently, applying the primer slurry onto one surface, two surfaces, or a part of the surface of the positive current collector, and then performing drying and cold-pressing to form a primer coating.

S12: Applying a positive active material slurry onto the primer coating, and performing drying and cold-pressing to form a positive active layer and obtain the positive electrode plate.

The positive active material slurry is prepared in advance by the following exemplary method: dispersing a positive active material, optionally a conductive agent, optionally a binder, and any other constituents into a solvent, and then stirring well to obtain a positive active material slurry. Applying the positive active material slurry onto the primer coating, and performing drying and cold-pressing to obtain a positive electrode plate.

Understandably, the steps of applying the slurry, drying, and cold-pressing are all conventional processes for electrode plates in the art, the details of which are omitted herein. The solvent may be, but without being limited to, N-methyl-pyrrolidone (NMP).

The preparation method disclosed by the applicant hereof differs in that the primer slurry includes inorganic particles, a conductive agent, a binder, and an alkali metal carbonate salt; the pH value of the primer slurry is 7 to 8; and the primer slurry forms a primer coating between the positive current collector and the positive active material layer.

Without intending to be limited by any theory or explanation, the applicant hereof unexpectedly finds that, by adding an alkali metal carbonate salt into the primer slurry, the primer slurry is made alkaline, and the pH value of the primer slurry is caused to be 7 to 8, thereby being conducive to uniform distribution of the conductive agent in the primer slurry, that is, uniform distribution of the conductive agent in the primer coating. In the primer coating, the uniformly distributed conductive agent can provide a relatively large number of conductive paths, thereby improving the interfacial contact between the primer coating and the positive active material layer, and in turn, improving the low-temperature discharge performance and cycle performance of the electrochemical device. On the other hand, the primer coating formed between the positive current collector and the positive active material layer can effectively reduce dangerous short-circuit points between the positive current collector and the negative active material layer, and increase the short-circuit resistance when the electrochemical device is short-circuited, thereby reducing the heat generation power in a case of short-circuiting, and improving the safety performance of the electrochemical device. Therefore, the electrochemical device containing the positive electrode plate prepared by the above preparation method exhibits a high level of safety performance, low-temperature discharge performance, and cycle performance simultaneously.

A third aspect of this application provides an electrochemical device. The electrochemical device includes: the positive electrode plate according to the first aspect or a positive electrode plate prepared by the preparation method according to the second aspect, a negative electrode plate, a separator, and an electrolyte solution.

The material, composition, and manufacturing method of the negative electrode plate used in the electrochemical device of this application may include any technology well-known in the prior art.

The negative current collector of the negative electrode plate is not particularly limited in this application. The negative current collector may be made of a metal foil or a porous metal sheet, for example, a foil or porous plate made of metal such as copper, nickel, titanium, or iron, or an alloy thereof. As an example, the negative current collector is a copper foil.

In some embodiments, the negative current collector includes two surfaces opposite to each other in a thickness direction of the current collector. The negative active material layer may be disposed on either or both of the two surfaces of the negative current collector. For example, the negative current collector includes two surfaces opposite to each other in a thickness direction of the current collector, and the negative active material layer is disposed on any one or both of the two surfaces on the two opposite sides of the negative current collector.

The type of the negative active material in the negative active material layer is not particularly limited herein, and may be selected as required. As an example, the negative active material includes, but is not limited to, at least one of natural graphite, artificial graphite, mesocarbon microbeads (MCMB), hard carbon, soft carbon, silicon, a silicon-carbon composite, SiO, a Li—Sn alloy, a Li—Sn—O alloy, Sn, SnO, SnO₂, spinel-structured Li₄Ti₅O₁₂, or a Li—Al alloy.

In some embodiments, the negative active material layer further optionally includes a binder. The specific type of the binder is not particularly limited, and may be selected as required. As an example, the binder includes, but is not limited to, at least one of styrene-butadiene rubber (SBR), polyvinylidene difluoride (PVDF), polytetrafluoroethylene (PTFE), polyvinyl butyral (PVB), water-based acrylic resin (Water-based acrylic resin), or carboxymethyl cellulose.

In some embodiments, the negative active material layer further optionally includes a conductive agent. The specific type of the conductive agent is not particularly limited, and may be selected as required. As an example, the conductive agent includes, but is not limited to, at least one of conductive graphite, superconductive carbon, acetylene black, carbon black, Ketjen black, carbon dots, carbon nanotubes, graphene, or carbon nanofibers.

In some embodiments, the negative active material layer further optionally includes other agents, such as a thickener (for example, sodium carboxymethyl cellulose (CMC-Na)).

However, this application is not limited to such materials. The negative electrode plate in this application may contain other well-known materials suitable for use as a negative active material, a conductive agent, a binder, or a thickener.

The negative electrode plate in this application may be prepared by a conventional method in this field. For example, a preparation method of the negative electrode plate includes: dispersing a negative active material, optionally a conductive agent, a binder, and a thickener in a solvent such as N-methyl-pyrrolidone (NMP) or deionized water to form a homogeneous negative electrode slurry, applying the negative electrode slurry onto a surface of a negative current collector, and performing steps such as oven-drying and cold-pressing to obtain a negative electrode plate.

The negative electrode plate of this application does not exclude other additional functional layers different from the negative active material layer. For example, in some embodiments, the negative electrode plate according to this application further includes a conductive primer coating (for example, formed of a conductive agent and a binder) disposed on a surface of the negative current collector and sandwiched between the negative current collector and the negative active material layer. In some other embodiments, the negative electrode plate according to this application further includes a protection layer overlaying the surface of the negative active material layer.

In some embodiments, the positive electrode plate, the negative electrode plate, and the separator may be made into an electrode assembly by winding or stacking.

The electrochemical device according to an embodiment of this application further includes an outer package configured to package the electrode assembly and the electrolyte solution. In some embodiments, the outer package may be a hard shell such as a hard plastic shell, an aluminum shell, a steel shell, or the like; or, may be a soft package such as a pouch-type package. The soft package may be made of a material such as at least one of polypropylene (PP), polybutylene terephthalate (PBT), or polybutylene succinate (PBS). The shape of the electrochemical device is not particularly limited in this application, and may be cylindrical, prismatic or in any other shape.

The positive electrode plate, the negative electrode plate, and the separator may be made into an electrode assembly by winding or stacking. The electrode assembly is packaged in the outer package. The electrolyte solution infiltrates in the electrode assembly. The number of electrode assemblies included in an electrochemical device may be one or more, and may be determined by a person skilled in the art as actually required.

The electrolyte solution serves to conduct active ions between the positive electrode plate and the negative electrode plate. The electrolyte solution for use in the electrochemical device of this application may be an electrolyte solution known in the prior art. As an example, the electrolyte solution includes an organic solvent, a lithium salt, and optionally an additive. The types of the organic solvent, lithium salt, and additive are not particularly limited, and may be selected as required.

Disposed between the positive electrode plate and the negative electrode plate, the separator primarily serves to prevent a short circuit between the positive electrode plate and the negative electrode plate while allowing passage of active ions. The type of the separator is not particularly limited herein, and may be any well-known porous separator that is highly stable both chemically and mechanically. As an example, the material of the separator may be one or more selected from, but is not limited to, glass fiber, non-woven fabric, polyethylene, polypropylene, or polyvinylidene fluoride.

Although, in the above description of some embodiments of the electrochemical device, the beneficial effects that can be achieved by the electrochemical device of this application are mainly described by using a secondary battery as an example of the electrochemical device, a person skilled in the art easily understands that, when applied to other types of electrochemical devices, the technical solutions hereof can achieve the same beneficial effects. In the electrochemical device of this application, the conductive agent is evenly distributed in the primer coating, and the primer coating provides a relatively large number of conductive paths, thereby improving the interfacial contact between the primer coating and the positive active material layer, and in turn, improving the low-temperature discharge performance and cycle performance of the electrochemical device. Moreover, a relatively high resistance and a relatively low contact impedance are exhibited between the primer coating and the positive current collector, thereby increasing the short-circuit resistance when the electrochemical device is short-circuited, and in turn, reducing the heat generation power in a case of short-circuiting, and improving the safety performance of the electrochemical device. Therefore, when applied to other types of electrochemical devices, the technical solutions hereof can achieve the same beneficial effects.

A fourth aspect of this application provides an electrical device. The electrical device includes the electrochemical device according to the third aspect of this application.

The electrical device is not particularly limited in this application, and may be any electronic device known in the prior art. In some embodiments, the electrical device may include, but is not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, lithium-ion capacitor, or the like.

As an example, the electrical device is a battery electric vehicle, a hybrid electric vehicle, a plug-in hybrid electric vehicle, or the like.

The following describes some embodiments of this application. The embodiments described below are illustrative, and are merely intended to construe this application but not to limit this application. Unless techniques or conditions are otherwise expressly specified in an embodiment hereof, the techniques or conditions described in the literature in this field or in an instruction manual of the product are applicable in the embodiment. A reagent or instrument used herein without specifying a manufacturer is a conventional product that is commercially available in the market.

### Embodiment 1

### 1) Preparing a Positive Electrode Plate

Mixing 88 wt % inorganic particles, 5 wt % lithium polyacrylate, 5 wt % sodium polyacrylate, 5.0 wt % conductive carbon black, 1.6 wt % lithium carbonate, and 0.4 wt % sodium carbonate, adding an appropriate amount of N-methylpyrrolidone (NMP) solvent, and stirring well with a vacuum mixer to obtain a primer slurry, where the mass ratio of the lithium carbonate to the sodium carbonate is 4.0. Using an aluminum foil as a positive current collector, and applying the primer slurry evenly onto both surfaces of the aluminum foil. Performing drying and cold-pressing to form a 2 μm-thick primer coating on both surfaces of the aluminum foil.

Mixing 97.3 wt % LiCoO₂ (LCO), 1.6 wt % polyvinylidene fluoride (PVDF), and 1.1 wt % conductive carbon black, adding an appropriate amount of N-methylpyrrolidone (NMP) solvent, and stirring well with a vacuum mixer to obtain a positive active material slurry. Applying the positive active material slurry evenly onto a surface of the primer coating, and performing drying, cold-pressing, and slitting to obtain a positive electrode plate.

### 2) Preparing a Negative Electrode Plate

Mixing 97.7 wt % artificial graphite, 1.3 wt % carboxymethyl cellulose (CMC), and 1.0 wt % styrene-butadiene rubber (SBR), adding an appropriate amount of deionized water solvent, and stirring well with a vacuum mixer to obtain a negative active material slurry. Using a copper foil as a negative current collector, applying the negative active material slurry evenly onto a surface of the copper foil, and performing drying, cold-pressing, and slitting to obtain a negative electrode plate.

### 3) Preparing a Battery

Stacking the positive electrode plate, the separator, and the negative electrode plate sequentially, and winding the stacked structure to obtain an electrode assembly. Loading the electrode assembly into an outer package, injecting the electrolyte solution, and performing steps such as sealing, standing, chemical formation, and shaping to obtain a finished battery.

### Embodiments 2 to 5

The positive electrode plate is prepared in the same way as in Embodiment 1 except that the constituents of the primer slurry are adjusted. The total mass percent of lithium carbonate and sodium carbonate is the same as in Embodiment 1 but the mass ratio of lithium carbonate to sodium carbonate is different, as detailed in Table 2.

The preparation processes of the negative electrode plate and the battery are the same as in Embodiment 1.

### Embodiment 6

The positive electrode plate is prepared in the same way as in Embodiment 1 except that the constituents of the primer slurry are adjusted. The adjusted constituents of the primer slurry include: 90 wt % inorganic particles, 2.3 wt % lithium polyacrylate, 2.3 wt % sodium polyacrylate, 5.0 wt % conductive carbon black, 0.40 wt % lithium carbonate, and 0.10 wt % sodium carbonate, where the mass ratio of lithium carbonate to sodium carbonate is 4.0.

The preparation processes of the negative electrode plate and the battery in Embodiment 6 are the same as in Embodiment 1.

### Embodiments 7 to 8

The preparation process is the same as in Embodiment 6 except the total mass percent of the binder (lithium polyacrylate and sodium polyacrylate) and the total mass of the alkali metal carbonate salts (lithium carbonate and sodium carbonate), as detailed in Table 2.

### Embodiment 9

The positive electrode plate is prepared in the same way as in Embodiment 1 except that the constituents of the primer slurry are adjusted. The adjusted constituents of the primer slurry include: 88.5 wt % inorganic particles, 2.5 wt % lithium polyacrylate, 2.5 wt % sodium polyacrylate, 5.0 wt % conductive carbon black, 1.20 wt % lithium carbonate, and 0.30 wt % sodium carbonate, where the mass ratio of lithium carbonate to sodium carbonate is 4.0.

The preparation processes of the negative electrode plate and the battery in Embodiment 9 are the same as in Embodiment 1.

### Embodiments 10 to 12

The preparation process is the same as in Embodiment 9 except the mass percent of the inorganic particles and the binder in the primer slurry, as detailed in Table 2.

### Embodiment 13

The positive electrode plate is prepared in the same way as in Embodiment 1 except that the constituents of the primer slurry are adjusted. The adjusted constituents of the primer slurry include: 90 wt % inorganic particles, 0.25 wt % lithium polyacrylate, 0.25 wt % sodium polyacrylate, 9.0 wt % conductive carbon black, 0.40 wt % lithium carbonate, and 0.10 wt % sodium carbonate, where the mass ratio of lithium carbonate to sodium carbonate is 4.0.

The preparation processes of the negative electrode plate and the battery in Embodiment 13 are the same as in Embodiment 1.

### Embodiments 14 to 15

The preparation process is the same as in Embodiment 13 except the total mass percent of the binder and the total mass percent of the conductive agent and the alkali metal carbonate salts. The rest is the same as in Embodiment 13, as detailed in Table 2.

### Embodiment 16

The positive electrode plate is prepared in the same way as in Embodiment 1 except that the constituents of the primer slurry are adjusted. The adjusted constituents of the primer slurry include: 88 wt % inorganic particles, 5 wt % lithium polyacrylate, 5 wt % sodium polyacrylate, 5 wt % conductive carbon black, 1.60 wt % potassium carbonate, and 1.60 wt % lithium carbonate.

The preparation processes of the negative electrode plate and the battery in Embodiment 16 are the same as in Embodiment 1.

### Embodiment 17

The positive electrode plate is prepared in the same way as in Embodiment 1 except that the constituents of the primer slurry are adjusted. The adjusted constituents of the primer slurry include: 88 wt % inorganic particles, 5 wt % lithium polyacrylate, 5 wt % sodium polyacrylate, 5 wt % conductive carbon black, and 2.0 wt % sodium bicarbonate.

The preparation processes of the negative electrode plate and the battery in Embodiment 17 are the same as in Embodiment 1.

### Embodiment 18

The positive electrode plate is prepared in the same way as in Embodiment 1 except that the constituents of the primer slurry are adjusted. The adjusted constituents of the primer slurry include: 88 wt % inorganic particles, 5 wt % lithium polyacrylate, 5 wt % sodium polyacrylate, 5 wt % conductive carbon black, and 1.6 wt % potassium bicarbonate.

The preparation processes of the negative electrode plate and the battery in Embodiment 18 are the same as in Embodiment 1.

### Embodiment 19

The positive electrode plate is prepared in the same way as in Embodiment 1 except that the constituents of the primer slurry are adjusted. The adjusted constituents of the primer slurry include: 88 wt % inorganic particles, 5 wt % lithium polyacrylate, 5 wt % sodium polyacrylate, 5 wt % conductive carbon black, and 1.6 wt % lithium bicarbonate.

The preparation processes of the negative electrode plate and the battery in Embodiment 19 are the same as in Embodiment 1.

### Comparative Embodiment 1

The positive electrode plate is prepared in the same way as in Embodiment 1 except that the constituents of the primer slurry are adjusted. The adjusted constituents of the primer slurry include: 90 wt % inorganic particles, 2.50 wt % lithium polyacrylate, 2.50 wt % sodium polyacrylate, and 5 wt % conductive carbon black.

The preparation processes of the negative electrode plate and the battery in Comparative Embodiment 1 are the same as in Embodiment 1.

### Comparative Embodiment 2

The positive electrode plate is prepared in the same way as in Embodiment 1 except that the constituents of the primer slurry are adjusted. The adjusted constituents of the primer slurry include: 88 wt % inorganic particles, 2.50 wt % lithium polyacrylate, 2.50 wt % sodium polyacrylate, 5 wt % conductive carbon black, and 2.0 wt % sodium carbonate.

The preparation processes of the negative electrode plate and the battery in Comparative Embodiment 2 are the same as in Embodiment 1.

### Comparative Embodiment 3

The positive electrode plate is prepared in the same way as in Embodiment 1 except that the constituents of the primer slurry are adjusted. The adjusted constituents of the primer slurry include: 90 wt % inorganic particles, 4.0 wt % lithium polyacrylate, 4.0 wt % sodium polyacrylate, and 2.0 wt % conductive carbon black.

The preparation processes of the negative electrode plate and the battery in Comparative Embodiment 3 are the same as in Embodiment 1.

### Comparative Embodiment 4

The positive electrode plate is prepared in the same way as in Embodiment 1 except that the constituents of the primer slurry and the thickness of the primer coating are adjusted. The adjusted constituents of the primer slurry include: 88 wt % inorganic particles, 2.5 wt % lithium polyacrylate, 2.5 wt % sodium polyacrylate, 5.0 wt % conductive carbon black, and 2.0 wt % lithium carbonate.

The preparation processes of the negative electrode plate and the battery in Comparative Embodiment 4 are the same as in Embodiment 1.

The preparation parameters and test data of each embodiment and comparative embodiment are shown in Table 2.

### Performance Test

The batteries in Embodiments 1 to 19 and Comparative Embodiments 1 to 4 are subjected to the following test.

### (1) Nail Penetration Test

Taking battery specimens in groups, with 10 batteries per group. Charging the batteries in a 25±3° C. environment until a full capacity (charging the batteries at a constant current of 0.5 C until the voltage reaches 4.5V, and then charging the batteries at a constant voltage until the current diminishes to a cut-off value of 0.05 C). Penetrating the batteries with nails at normal temperature (by using a steel nail that is 4 mm in diameter and made of carbon steel, with a taper degree of 16.5 mm and a total length of 100 mm), where the nail penetration speed is set to 30 mm/s, and the nail penetration reaches such a depth that the taper of the steel nail passes through the battery. A battery is deemed to pass through the nail penetration test if the battery does not catch fire or explode after being penetrated. The nail penetration performance is expressed by the nail penetration test pass rate, denoted as N₁/N₀, where N₁ represents the number of batteries that pass the nail penetration test, and N₀ represents the number of battery specimens, that is, N₀=10.

### (2) Testing the Cycle Performance

Leaving the battery to stand in a 45° C.±3° C. environment for 30 minutes, and cycling the battery according to the following steps: charging the battery at a constant current of 1.25 C until the voltage reaches 4.25 V, and then charging the battery at a constant current of 1.5 C until the voltage reaches 4.5 V, and then charging the battery at a constant voltage until the current diminishes to a cut-off value of 0.05 C; leaving the battery to stand for 30 minutes; and then discharging the battery at a constant current of 0.7 C until the voltage reaches 3.0 V. Recording the capacity of the battery at the end of each cycle, and using the number of cycles corresponding to the battery capacity fading to 80% of the initial capacity as the cycle life of the battery.

### (3) Testing the Low-Temperature Discharge Performance

Leaving the battery to stand in a 25° C.±3° C. environment for 5 minutes, and then charging the battery at a constant current of 1.5 C until the voltage reaches 4.5 V, and then charging the battery at a constant voltage until the current diminishes to a cut-off value of 0.02 C; adjusting the furnace temperature to −10° C.; leaving the battery to stand for 60 minutes; and discharging the battery at a constant current of 0.2 C until the voltage drops to 3.0 V, and recording the discharge capacity retention rate.

### (4) Testing the Bonding Force Between the Primer Coating and the Positive Current Collector

Disassembling a battery and taking out a positive electrode plate. Soaking the positive electrode plate in DMC, and then baking the positive electrode plate in an 80° C. oven for 30 minutes. Peeling off the superficial positive active material layer by using 3M adhesive tape, and then sticking a side, overlaid with a primer coating, of the positive electrode plate to a smooth steel sheet by using double-sided tape, and sticking the other side of the positive electrode plate by using adhesive tape. Fixing one end of the adhesive tape onto a tensile tester, and pulling the adhesive tape by using the tensile tester. Reading the bonding force exerted when the adhesive tape is stretched. Exporting the numerical value, and dividing the value by the width of the adhesive tape to obtain the bonding force F N/m between the primer coating and the positive current collector.

### (5) Testing the Sheet Resistance

Disassembling a battery and taking out a positive electrode plate. Soaking the positive electrode plate in DMC, and then baking the positive electrode plate in an 80° C. oven for 30 minutes. Peeling off the superficial positive active material layer by using 3M adhesive tape, and then measuring the sheet resistance by using a sheet resistance meter. The sheet resistance is measured by applying a pressure of 0.4 T and holding the pressure for a time of 10 s. The value displayed by the sheet resistance meter is the sheet resistance at each different test point.

For each primer coating, at least 3 test points may be randomly selected. The average value of the measured sheet resistances is used as the sheet resistance R Q of the primer coating.

### (6) Observing and Testing the Agglomerated Conductive Agent Particles on the Surface of the Primer Coating

Obtaining a specimen: Disassembling a battery and taking out a positive electrode plate; soaking the positive electrode plate in DMC, and then baking the positive electrode plate in an 80° C. oven for 30 minutes; peeling off the superficial positive active material layer by using 3M adhesive tape to obtain the positive electrode plate with an exposed primer coating; using a piece of 90 mm×30 mm region as a specimen to be observed; or, when the primer coating is exposed on the positive electrode plate, taking a piece of 90 mm×30 mm region in size from the part, with the exposed primer coating, of the positive electrode plate directly to serve as a specimen to be observed.

Placing the specimen onto a specimen holder, using a CCD observation probe with a diameter of 1 cm, adjusting the distance between the CCD observation probe and the specimen holder to 3 cm, adjusting the magnification to 20×, and determining the number of conductive agent particles agglomerated on the surface of the specimen.

### (7) Testing the pH Value of the Powder

When a primer coating is exposed on the positive electrode plate, taking the part, with the exposed primer coating, of the positive electrode plate directly, and scraping off the primer coating; or, disassembling a battery and taking out a positive electrode plate, soaking the positive electrode plate in DMC, baking the positive electrode plate in an 80° C. oven for 30 minutes, and then peeling off the superficial positive active material layer by using 3M adhesive tape, and then soaking approximately 1 gram of primer coating in 50 ml of deionized water in a 25° C. environment, stirring the solution with a magnetic stirrer at a speed of 30 r/min for 12 hours so that the primer coating is automatically dispersed in the deionized water, and then measuring the pH value of the solution by using a pH tester.

TABLE 2

| | | | | | | | | | Number of | | Low- |
|---|---|---|---|---|---|---|---|---|---|---|---|
| | | | | | | Mass ratio of | | | conductive | | temperature |
| | Mass | | | Mass | Mass | lithium | | | agent particles | | discharge |
| | percent of | | Mass | percent of | percent of | carbonate to | Mass percent | | agglomerated | Cycle | capacity |
| | inorganic | | percent of | lithium | sodium | the sodium | of conductive | pH of | within an area | life | retention |
| Serial number | particles | | binder | carbonate | carbonate | carbonate | carbon black | powder | of 2700 mm² | (cls) | rate |
| Embodiment 1 | 88 | wt % | 10.0% | 1.60% | 0.40% | 4.0 | 5% | 7.6 | 1 | 760 | 75% |
| Embodiment 2 | 88 | wt % | 10.0% | 1.00% | 1.00% | 1.0 | 5% | 7.8 | 0 | 740 | 70% |
| Embodiment 3 | 88 | wt % | 10.0% | 1.33% | 0.67% | 2.0 | 5% | 7.7 | 1 | 755 | 73% |
| Embodiment 4 | 88 | wt % | 10.0% | 1.50% | 0.50% | 3.0 | 5% | 7.65 | 2 | 748 | 72% |
| Embodiment 5 | 88 | wt % | 10.0% | 0.33% | 1.67% | 0.5 | 5.0% | 8.2 | 0 | 735 | 65% |
| Embodiment 6 | 90 | wt % | 4.6% | 0.40% | 0.10% | 4.0 | 5% | 7.6 | 1 | 759 | 71% |
| Embodiment 7 | 90 | wt % | 4.2% | 0.70% | 0.18% | 4.0 | 5% | 7.6 | 1 | 754 | 72% |
| Embodiment 8 | 90 | wt % | 3.6% | 1.10% | 0.28% | 4.0 | 5% | 7.6 | 2 | 765 | 71% |
| Embodiment 9 | 88.5 | wt % | 5.0% | 1.20% | 0.30% | 4.0 | 5% | 7.6 | 0 | 755 | 70% |
| Embodiment 10 | 86.25 | wt % | 7.0% | 1.40% | 0.35% | 4.0 | 5% | 7.6 | 0 | 749 | 70% |
| Embodiment 11 | 83.0625 | wt % | 10.0% | 1.55% | 0.39% | 4.0 | 5% | 7.6 | 1 | 760 | 71% |
| Embodiment 12 | 81 | wt % | 12.0% | 1.60% | 0.40% | 4.0 | 5.0% | 7.6 | 1 | 700 | 62% |
| Embodiment 13 | 90 | wt % | 0.5% | 0.40% | 0.10% | 4.0 | 9% | 7.6 | 1 | 758 | 71% |
| Embodiment 14 | 90 | wt % | 1.5% | 0.70% | 0.18% | 4.0 | 7.6% | 7.6 | 1 | 760 | 72% |
| Embodiment 15 | 90 | wt % | 3.0% | 1.10% | 0.28% | 4.0 | 5.6% | 7.6 | 2 | 748 | 71% |

| | | | | | | | | | | |
|---|---|---|---|---|---|---|---|---|---|---|
| Embodiment 16 | 88 | wt % | 10.0% | 1.6% lithium | / | 5.0% | 7.7 | 1 | 740 | 71% |
| | | | | carbonate + 1.6% | | | | | | |
| | | | | potassium carbonate | | | | | | |
| Embodiment 17 | 88 | wt % | 10.0% | 2% sodium | / | 5.0% | 7.8 | 2 | 752 | 73% |
| | | | | bicarbonate | | | | | | |
| Embodiment 18 | 88 | wt % | 10% | 1.6% potassium | / | 5.0% | 7.4 | 1 | 748 | 70% |
| | | | | bicarbonate | | | | | | |
| Embodiment 19 | 88 | wt % | 10% | 1.6% lithium | / | 5.0% | 7.2 | 1 | 748 | 74% |
| | | | | bicarbonate | | | | | | |

| | | | | | | | | | | |
|---|---|---|---|---|---|---|---|---|---|---|
| Comparative | 90% | 5.0% | / | / | / | 5.0% | 4.6 | 5 | 500 | 60% |
| Embodiment 1 | | | | | | | | | | |
| Comparative | 88.0% | 5.0% | / | 2.0% | 0 | 5.0% | 10 | 12 | 595 | 59% |
| Embodiment 2 | | | | | | | | | | |
| Comparative | 90% | 8.0% | 0 | 0 | / | 2.0% | 4.2 | 8 | 547 | 61% |
| Embodiment 3 | | | | | | | | | | |
| Comparative | 88.0% | 5.0% | 2.0% | 0 | / | 5.0% | 9.4 | 15 | 621 | 65% |
| Embodiment 4 | | | | | | | | | | |

As can be seen from Embodiments 1 to 5 in Table 2, the primer slurry includes lithium carbonate and sodium carbonate (at mass ratio of 0.5 to 4), the pH value of the primer coating powder falls within a range of 7 to 8, and the number of conductive agent particles agglomerated within an area of 2700 mm² does not exceed 2 (the conductive agent is evenly distributed), so that the cycle life and the low-temperature discharge capacity retention rate are relatively high. In other words, the lithium carbonate and sodium carbonate mixed at a mass ratio of 0.5 to 4 makes the pH value of the primer slurry alkaline, thereby being conducive to uniform distribution of the conductive agent in the primer slurry, and increasing the conductive paths in the primer coating, and in turn, significantly improving the cycle life and low-temperature discharge performance of the battery.

In Embodiments 1 to 5, when the mass ratio of lithium carbonate to sodium carbonate falls within the range of 0.5 to 4, with the decrease of the mass percent of lithium carbonate, the corresponding cycle life and discharge capacity retention rate are also relatively reduced on the whole. As can be seen, by reasonably adjusting the ratio of sodium carbonate to lithium carbonate and increasing the mass percent of lithium carbonate, the cycle life and the discharge capacity retention rate can be increased, that is, both the cycle performance and the low-temperature discharge performance are improved. That is because the lithium carbonate can not only donate carbonate ions in the primer coating and make the primer slurry alkaline, which contributes to uniform distribution of the conductive agent in the primer coating, but also donate lithium ions, thereby being conducive to charge exchange during charge and discharge. In addition, the lithium carbonate can participate in intercalation and deintercalation reactions of lithium ions during charge and discharge, thereby improving the transmission rate and reactivity of lithium ions in the positive active material. This endows the battery with a good cycle life and low-temperature discharge performance.

As can be seen from Embodiments 6 to 12 in Table 2, the mass percent of the binder falls within the range of 0.5% to 10%, the mass ratio of lithium carbonate to sodium carbonate is 4, the pH value of the corresponding primer coating powder is 7.6, and the number of conductive agent particles agglomerated within an area of 2700 mm² does not exceed 2 (the conductive agent is evenly distributed), so that the cycle life and the low-temperature discharge capacity retention rate are relatively high.

As can be seen from Embodiments 13 to 15 in Table 2, the mass ratio of lithium carbonate to sodium carbonate is 4. The mass ratio between the binder, the conductive agent, and the alkali metal carbonate salt is adjusted to an appropriate value so that the number of conductive agent particles agglomerated within an area of 2700 mm² does not exceed 2 (the conductive agent is evenly distributed), and in turn, the cycle life and the low-temperature discharge capacity retention rate are relatively high.

In Embodiments 16 to 19, the alkali metal carbonate salt includes potassium carbonate, lithium carbonate, sodium bicarbonate, lithium bicarbonate, or other possible carbonate salts. These alkali metal carbonate salts can effectively ionize into carbonate ions or bicarbonate ions, thereby making the primer slurry alkaline, and being conducive to uniform distribution of the conductive agent.

In contrast, in Comparative Embodiments 1 and 3, the primer slurry includes no alkali metal carbonate salt, the pH value of the primer coating powder is acidic, the conductive agent is unevenly distributed, and the cycle life and low-temperature discharge performance are lower than those of Embodiments 1 to 19. As can be seen from Comparative Embodiment 1 or 3 versus any one of Embodiments 1 to 4, the alkali metal carbonate salt makes the primer slurry alkaline, and is conducive to uniform distribution of the conductive agent, and provides a uniform conductive network, thereby improving the cycle life and low-temperature discharge performance.

As can be seen from Comparative Embodiments 2 and 4, in Comparative Embodiments 1 and 3 and Embodiments 1 to 19, the primer slurry contains both lithium carbonate and sodium carbonate, thereby being more conducive to uniform distribution of the conductive agent.

The nail penetration performance in Embodiments 1 to 19 and Comparative Embodiments 1 to 4 is 10/10, that is, the number of batteries that have passed the nail penetration test is 10, indicating good nail penetration performance. Based on the fact that the primer coating in each embodiment and comparative embodiment includes inorganic particles, the primer coating disposed between the positive current collector and the positive active material layer can effectively reduce dangerous short-circuit points between the positive current collector and the negative active material layer, and endow the battery with good nail penetration performance.

Finally, it is hereby noted that the foregoing embodiments are merely intended to describe the technical solutions of this application but not to limit this application. Based on the concept of this application, the technical features in the foregoing embodiments or different embodiments may be combined, the steps may be implemented in any order, and many variations may be made to this application in different aspects, which, for brevity, are not provided in detail. Although this application has been described in detail with reference to the foregoing embodiments, a person of ordinary skill in the art understands that modifications may still be made to the technical solutions described in the foregoing embodiments, or equivalent replacements may still be made to some technical features in the technical solutions. Such modifications and replacements do not make the essence of the corresponding technical solutions depart from the scope of the technical solutions of the embodiments of this application.

What is claimed is:

1. A positive electrode plate, wherein, the positive electrode plate comprises a positive current collector, a primer coating disposed on at least one surface of the positive current collector, and a positive active material layer disposed on a surface of the primer coating; and
the primer coating comprises inorganic particles, a conductive agent, and a binder, and a number of particles of the conductive agent agglomerated on the surface of the primer coating within an area of 2700 mm² is less than or equal to 2.

2. The positive electrode plate according to claim 1, wherein, a difference between a sheet resistance of any two 154.025 mm² regions on the primer coating is less than 1Ω.

3. The positive electrode plate according to claim 1, wherein, a pH value of powder of the primer coating is 7 to 8.

4. The positive electrode plate according to claim 1, wherein, the primer coating further comprises an alkali metal carbonate salt.

5. The positive electrode plate according to claim 4, wherein, the alkali metal carbonate salt comprises one or more selected from the group consisting of sodium carbonate, lithium carbonate, potassium carbonate, sodium bicarbonate, lithium bicarbonate, and potassium bicarbonate.

6. The positive electrode plate according to claim 5, wherein, the alkali metal carbonate salt comprises the sodium carbonate and the lithium carbonate.

7. The positive electrode plate according to claim 1, wherein, based on a total mass of the primer coating, the primer coating comprises the inorganic particles added at a mass percentage of 80 wt % to 90 wt %, the conductive agent added at a mass percentage of 3 wt % to 20 wt %, the binder added at a mass percentage of 0.5 wt % to 10 wt %, and an alkali metal carbonate salt added at a mass percentage of 0.5 wt % to 2 wt %.

8. The positive electrode plate according to claim 7, wherein, the binder is an alkali metal polyacrylate salt binder.

9. The positive electrode plate according to claim 8, wherein, the alkali metal polyacrylate salt binder comprises lithium polyacrylate and sodium polyacrylate.

10. The positive electrode plate according to claim 6, wherein, a mass ratio of the lithium carbonate to the sodium carbonate is 0.5 to 4.

11. The positive electrode plate according to claim 10, wherein, the mass ratio of the lithium carbonate to the sodium carbonate is 2 to 4.

12. The positive electrode plate according to claim 1, wherein, a thickness of the primer coating is 1 μm to 5 μm.

13. A method for preparing the positive electrode plate according to claim 1, the method comprising:
applying a primer slurry onto the at least one surface of the positive current collector, and then performing drying and cold-pressing to form the primer coating, wherein, the primer slurry comprises the inorganic particles, the conductive agent, the binder, and the alkali metal carbonate salt, and a pH value of the primer slurry is 7 to 8; and
applying a positive active material slurry onto the primer coating, and performing drying and cold-pressing to form the positive active material layer and obtain the positive electrode plate.

14. The method according to claim 13, wherein, a mass ratio between the inorganic particles, the conductive agent, the binder, and the alkali metal carbonate salt is (80 to 90):(3 to 20):(0.5 to 10):(0.5 to 2).

15. The method according to claim 14, wherein, the alkali metal carbonate salt comprises one or more selected from the group consisting of sodium carbonate, lithium carbonate, potassium carbonate, sodium bicarbonate, lithium bicarbonate and potassium bicarbonate.

16. The method according to claim 15, wherein, the alkali metal carbonate salt comprises the sodium carbonate and the lithium carbonate.

17. The method according to claim 16, wherein, a mass ratio of the lithium carbonate to the sodium carbonate is 0.5 to 4.

18. The method according to claim 17, wherein, a mass ratio of the lithium carbonate to the sodium carbonate is 2 to 4.

19. An electrochemical device, wherein, the electrochemical device comprises the positive electrode plate as claimed in claim 1.

20. The electrochemical device according to claim 19, wherein, a pH value of powder of the primer coating is 7 to 8.
